(19) United States
(12) Patent Application Publication
(10) Pub. No.: US 2010/0223341 A1
(43) Pub. Date: Sep. 2, 2010

(54) ELECTRONIC MESSAGING TAILORED TO USER INTEREST

(75) Inventors: Dragos A. Manolescu, Kirkland, WA (US); Matthew Jason Pope, Seattle, WA (US); Raymond E. Ozzie, Seattle, WA (US); Christopher H. Pratley, Seattle, WA (US); Henricus Johannes Maria Meijer, Mercer Island, WA (US); F. David Jones, Bellevue, WA (US); Mary P. Czerwinski, Woodinville, WA (US)

Correspondence Address: LEE & HAYES, PLLC, 601 W. RIVERSIDE AVENUE, SUITE 1400, SPOKANE, WA, 99201, US

(73) Assignee: Microsoft Corporation, Redmond, WA (US)

(21) Appl. No.: 12/394,237

(22) Filed: Feb. 27, 2009

(51) Int. Cl. G06F 15/16; G06F 17/30; G06F 15/173

(52) U.S. Cl. 709/206; 709/224; 707/E17.014; 707/E17.044

(57) ABSTRACT

Providing for electronic messaging tailored to contexts or interests of one or more participants of electronic communication is described herein. By way of example, a message can be analyzed during or after compilation to determine a context of the message. Message participants can be identified and a context for such participants determined. Based on the message context or participant context, the message can be modified to be consistent with interests, preferences or other context of one or more participants. In some aspects, the message can be modified upon receipt by a recipient's communication device or messaging application. According to other aspects, the message can be modified at compilation, or transmission. In accordance with still other aspects, message modifications can be output as suggested feedback to improve receptivity or utility of a message.

### BACKGROUND

E-mail and other electronic messaging systems have enabled a technical revolution in business and personal communications, and have provided a platform for social and organizational networking. In recent years, use of electronic messaging, such as e-mail, short messaging, text messaging, blogging, electronic forums, and so on, has increased exponentially due to the inexpensive and near instantaneous communication platform that electronic messaging provides. Such platforms have rapidly decreased time required to share and disseminate information, whether for a large, multi-national organization, a network of friends or family members, or remotely located small business partners.

The advent of electronic messaging, whether via fixed line communications (e.g., desktop computer) or mobile communications (e.g., cellular phone), has led to diverse business ventures supporting this technology. Initially, such ventures were limited to large organizations with enough capital to support initial infrastructure investments required for long range electronic communication. For instance, the Internet was initially a defense research project funded with military and university funds. As commercial applications became apparent, private sector ventures leveraged the initial structure to establish public and private links to the initial architecture. The first forms of electronic messaging over the Internet consisted of e-mail; however, the versatile transport control protocol/Internet protocol (TCP/IP) enabled other messaging architectures, such as short message service (SMS), text messaging, and so forth, to couple with the basic communication infrastructure. As the World Wide Web expanded across the Internet infrastructure and hypertext transport protocol (HTTP) and other protocol web pages became a prevalent form of data exchange, message forums, blogging and other forms of Web-based electronic messaging became popular. One of the more sophisticated recent advancements are the social networking sites that inter-link individuals, or nodes, based on inter-personal relationships, or edges. These sites provide a simple and powerful platform to share information, communicate real-time or in delayed-time (e.g., via posting on a forum), and so on.

Generally speaking, users of an electronic messaging platform often employ one or more messaging systems to communicate, but many have a platform that they prefer over others. As users become familiar with features, interface functionality or advanced programming, some resistance to adapting to a new platform or application is fairly common. However, as communication systems become more and more integrated, incorporating common features across multiple messaging platforms, some of the initial resistance becomes obviated. Thus, for instance, e-mail or IM users have an increased tendency to adapt to newer platforms, such as social networking platforms, which incorporate popular features of a popular, earlier system. As the user base for new applications and messaging platforms expands, the overall inter-connectivity of individuals is enhanced, leading to increased efficiency in communication, both in business and in social contexts.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

The subject disclosure provides for tailoring electronic messaging to contexts or interests of one or more participants of a communication. In some aspects, a message can be analyzed during or after compilation to determine a context of the message. Message participants, including sender, recipient, those copied on the message, and so on, can be identified and a context for such participants determined. In at least some aspects, logistical information can be analyzed to determine a logistical context for the user, such as user position location during message compilation or receipt, whether the user is stationary or in transmit (e.g., including velocity or direction of travel, rate of acceleration), ambient temperature, local time, and so forth. Based on the message context or participant context, the message can be modified to be consistent with participant context. In some aspects, the message can be modified upon receipt by a particular recipient's communication device or messaging application. According to other aspects, the message can be modified at compilation, or sending. In accordance with still other aspects, proposed modifications can be suggested to a user sending, forwarding, replying to, etc., the message.

In addition to the foregoing, the subject disclosure provides for data mining to collect a rich set of contextual data pertinent to messaging contexts, participant contexts, participant preferences, or a combination thereof. Data mining can be conducted over network data stores and data servers, such as the Internet or private intranets, as well as data stores on communication devices (e.g., hard drive, Flash memory, etc.). Mined data is filtered with respect to message context or participant context or subjects of interest. Additionally, data can be weighted relative the contexts/interests, and a subset of data meeting a relevance threshold can be selected and utilized to modify an electronic message, or to provide suggested modifications for the message. Accordingly, a rich set of data can be accessed and utilized to customize electronic messaging to participants of electronic communication.

The following description and the annexed drawings set forth in detail certain illustrative aspects of the claimed subject matter. These aspects are indicative, however, of but a few of the various ways in which the principles of the claimed subject matter may be employed and the claimed subject matter is intended to include all such aspects and their equivalents. Other advantages and distinguishing features of the claimed subject matter will become apparent from the following detailed description of the claimed subject matter when considered in conjunction with the drawings.

### BRIEF DESCRIPTION OF THE DRAWINGS

FIG. 1 illustrates a block diagram of a sample system that provides electronic messaging customized for message participants according to disclosed aspects.

FIG. 2 depicts a block diagram of an example system that provides messaging feedback based on participant context according to further aspects.

FIG. 3 depicts a block diagram of an example system that determines user context and interests relevant to electronic messaging.

FIG. 4 illustrates a block diagram of an example system that provides data mining pertinent to user interests, context or message context according to some aspects.

FIG. 5 depicts a block diagram of an example system that delivers customized messaging to user devices according to other aspects.

FIG. 6 illustrates a flowchart of an example methodology for customizing electronic messaging based on device usage context of messaging participants.

FIG. 7 depicts a flowchart of an example methodology for providing rich contextual data for customized electronic messaging according to further aspects.

FIG. 8 illustrates a flowchart of a sample methodology for providing predictive feedback for customizing electronic messaging to participant disposition.

FIG. 9 depicts a block diagram of a suitable operating environment for implementing customized electronic messaging according to various aspects.

FIG. 10 illustrates a block diagram of a sample remote communication environment providing data exchange between remote devices.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It may be evident, however, that the claimed subject matter may be practiced without these specific details. In other instances, well-known structures and devices are shown in block diagram form in order to facilitate describing the claimed subject matter.

As used in this disclosure, the terms “component,” “module,” “system”, “interface”, “engine”, or the like are generally intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a controller and the controller can be a component. One or more components may reside within a process and/or thread of execution and a component can be localized on one computer and/or distributed between two or more computers. As another example, an interface can include I/O components as well as associated processor, application, and/or API components, and can be as simple as a command line or a more complex Integrated Development Environment (IDE).

Communication networks have become powerful tools for sharing knowledge and experience in social settings as well as business settings. Currently, such networks can provide real-time dissemination of information, at almost any distance around the globe. Networks can be public, like the Internet and World Wide Web, or private, such as personal or business networks requiring authorized access to a limited subset of users. Furthermore, communication networks can employ wireless device access or fixed-line device access, or both. Additionally, sub-networks can exist within a larger network, such as a domain or sub-domain, having particular applications and application features, settings or preferences local to the sub-network. Accordingly, by selectively configuring a sub-network, distinctiveness is achieved, both in displaying information to a user, providing access to the user and in facilitating user control over various user-oriented applications.

Recent applications for communication networks include electronically characterizing human groups and organizations and providing a means of electronic communication between members thereof. Human interactions and relationships, termed social networks, include families, groups of friends, business and investment partners, instant message ‘buddies’, members of for profit and non-profit organizations, and the like. In one representation of inter-personal relationships, individual persons are characterized as nodes of a network, and ties between the nodes are based on various interactions and communications between the persons. Each person, or node, is directly connected to others whom the person has direct interaction with. Such person is indirectly connected with other persons, whom their direct contacts have direct interaction with, and still other persons who their direct contacts have indirect interaction with (through one or more other persons), and so on. Thus, in such a characterization of inter-personal relationships, a social network is analogous to a large web of interconnected person-nodes.

By storing node and connectivity data electronically, for instance in a database that tracks individual persons and their direct and indirect relationships, an underlying web of inter-personal relationships can generate an electronic social network. Some electronic social networks are maintained on Internet web sites, including sites such as Facebook®, Twitter™, LinkedIn.com®, and so forth. In addition, many corporations include electronic social networks maintained on private intranets, and some private individuals or businesses maintain electronic social networks on various public and private networks.

Electronic social networks can enable individuals to post or share data and media (e.g., photographs, videos, audio recordings, text, blogs, and the like) pertaining to their personal or business interests, hobbies, areas of expertise, research, political views, business ventures, investment portfolios or interests, and so on. In addition, an underlying communication network (e.g., Internet, intranet, mobile communication network, private network) supporting an electronic social network can facilitate electronic communication and data exchange between user nodes of such a social network, in the form of instant message (IM), short message service (SMS), e-mail, voice communication (e.g., voice over Internet Protocol [VoIP], or circuit-switched voice), or other forms of electronic communication. To interact with other network users or with network components supporting the social network, a communication device, such as a computer, mobile phone, laptop, personal digital assistant (PDA), or like electronic device is employed by a network user. Thus, the electronic device provides an interface to the electronic social network and consequently with other network users.

One great benefit provided by electronic social networks is the rich contextual information provided by or collected about users of such networks. Users can provide and update their personal status, such as current tasks, activities, commitments, meetings, etc., physical context, such as location or relative time of day, social or business contacts, relationships with such contacts, context of such relationships (e.g., family member, teammate, workgroup member, business associate, investment partner, etc.), and so forth. Additionally, electronic communications between persons and patterns of communications can provide additional contextual information. For instance, preferred communication devices, messaging applications, application/device features employed by users, communication content, rates of usage, time-based usage patterns, or the like, or suitable combinations thereof, can yield usage information pertaining to such persons. However, although such information exists, messaging and networking applications and devices do not utilize the power of the information in meeting or augmenting user interactions. As an example, users are required to utilize their own knowledge of personal or physical context of communication partners to manually format message content, style, or logistics to match interests, preferences, contexts or dispositions of partners.

The subject disclosure provides for inferring user context and generating modified content, style or format suited to customize electronic communication to participants thereof. Modifications can be automatically applied to an electronic message, or suggested to a participant as predictive feedback. In the latter case, a user can manually adapt the message or ignore the modifications, or have them automatically applied to the message based on user input. In addition, different modifications can be generated for different participant contexts, preferences or dispositions. Thus, for instance, different modifications to message content can be generated based on different contexts of a set of message recipients.

An alternative or additional aspect of message modification can comprise modifying a message to different electronic communication platforms. Thus, a message can be delivered to a first recipient via an e-mail application, and another recipient via a text messaging application, based on recipient preferences or contexts. As a more specific example, if a recipient is determined to be currently employing an e-mail application at a desktop computer to interface with a communication network, the message can be delivered via e-mail, whereas if the user is determined to be traveling and using a mobile phone to interface with the communication network, a short message service (SMS) message can be delivered instead.

Where suitable, cross-platform messaging can employed to adapt a message sent via one messaging platform to formats and protocols of a different messaging platform(s). As a particular example for illustrative purposes, an e-mail message is sent with attachments to three recipients. A first recipient is determined to be logged in to an e-mail application, a second determined to be employing a mobile phone (e.g., based on a threshold amount of user activity on the mobile phone within a threshold period of time) that does not have an e-mail but does employ an SMS service, and a third is determined to be in a meeting, logged off of communication devices associated with the user, or otherwise unavailable for immediate receipt of the communication. The first message can be delivered by the e-mail program, with automatic or suggested modifications to content, style, format, etc., as described herein). The second message can be transformed into a suitable SMS message. In this instance, the conversion can comprise converting the e-mail text into SMS text, scanning the attachments for content and analyzing the content for context (e.g., employing natural language processing or like language processing, and including the SMS text, attachment content or attachment context into a suitable SMS message. For the third recipient, user profile settings associated with communication devices/applications employed by the user, where available, can be referenced to determine a preferred platform or device for missed messages. Where no preferred platform or device is available, a default platform (e.g., the e-mail platform utilized to send the message) can be employed to deliver the message. It should be appreciated that many variations of message customization consistent with the scope of the subject disclosure and appended claims are possible, in addition to or in lieu of those examples specifically articulated herein. However, the disclosure is intended to embody, in addition to aspects specifically articulated, other suitable aspects made known by way of the context provided herein.

It should be appreciated that, as described herein, the claimed subject matter may be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). The aforementioned carrier wave, in conjunction with transmission or reception hardware and/or software, can also provide control of a computer to implement the disclosed subject matter. Of course, those skilled in the art will recognize many modifications may be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to present concepts in a concrete fashion. As used in this application and the amended claims, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form.

As used herein, the terms to “infer” or “inference” refer generally to the process of reasoning about or inferring states of the system, environment, and/or user from a set of observations as captured via events and/or data. Inference can be employed to identify a specific context or action, or can generate a probability distribution over states, for example. The inference can be probabilistic-that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources.

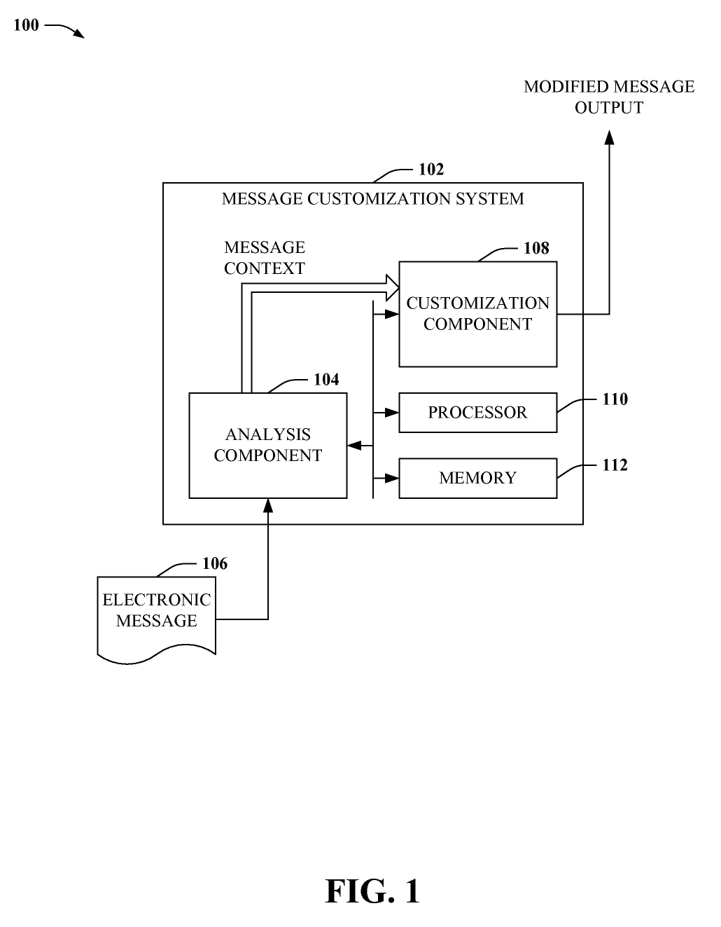

Turning now to the figures, FIG. 1 depicts a block diagram of an example system 100 that provides customization for electronic messaging based on context, interests or preferences of a message participant. Participant contexts can be determined individually or in the aggregate. Furthermore, customization of an electronic message 106 can result in a single variation of the message 106 or multiple variations, sent to different participants or groups of participants, based on different contexts. Accordingly, system 100 provides a flexible and powerful mechanism for tailoring electronic messaging to one or more message participants.

System 100 can comprise a message customization system 102 that outputs a modification to an electronic message 106 based at least in part on a context of the message 106. Message context can be determined by an analysis component 104 that evaluates content, style, format, language or logistics (e.g., best time to send a message, preferred recipient alias, address or device, etc.) pertaining to the message 106, or the like. Language processing (e.g., natural language processing) can be employed to evaluate the content of the message 106 and infer a baseline meaning for such content. In addition, style and format of the message 106, including writing style or a sentiment of a participant compiling the message, can be evaluated to further characterize message content and the meaning thereof. As an example, message length (e.g., number of words), detail (e.g., amount of descriptive or supportive data, including or excluding attachments, as suitable to participant preferences) and graphical illustrations, fonts, word styles, pictures, embedded video, audio or other media, links (e.g., hypertext transport mark-up language [HTML] links), including link destination, destination content or chains of links among multiple messages or websites, as well as other variations in style or decoration can be evaluated, in addition to the content. Particularly, natural language processing can be employed to analyze words employed in a message (e.g., words providing an inference of emotion), punctuation (e.g., exclamation marks, emoticons, questions marks, or the like, employed in conveying emotion or sentiment) employed in the message, explicit user input (e.g., message rating, message feedback, sender rating, etc.) or other indicators of personal sentiment (e.g., slang language, curse words, and so forth). As a result of the evaluation, analysis component 104 can infer a sentiment of a participant compiling the message 106 or responding to/forwarding the message 106, topics of interest discussed, planned events pertaining to the message content (e.g., social communication, business communication, special event, etc.), logistic information pertaining to such planned events, and so on. The overall evaluation can result in a context for the message.

It should be appreciated that analysis component 104 can be executed by a processing device 110 during compilation of the message content, or after compilation is complete. For instance, processor 110 can identify when a message (106) is initiated (e.g., when a new e-mail, or reply/forward e-mail is composed) and execute the analysis component 104 to evaluate message context as the message is formulated. In such case, output of system 100 can be updated to the message 106 or output to a message participant while the message 106 is compiled. Alternatively, processor 110 can infer when message compilation is complete, and then execute such component 104. As another alternative, processor 110 can execute the analysis component when a participant sends the message 106. When to execute the message evaluation can be specified in a user preference file (not depicted) stored in memory (112) of a communication device.

Once the message context is determined, a context output is generated and stored in memory 112, and provided to a customization component 108. The customization component can generate one or more modifications to the message 106, including message content, style, format, logistics, participants to add to or delete from the message, or the like, based on the message context and context of one or more participants. As utilized herein, a message participant can include a sender(s) or recipients, whether copied, replied to or forwarded.

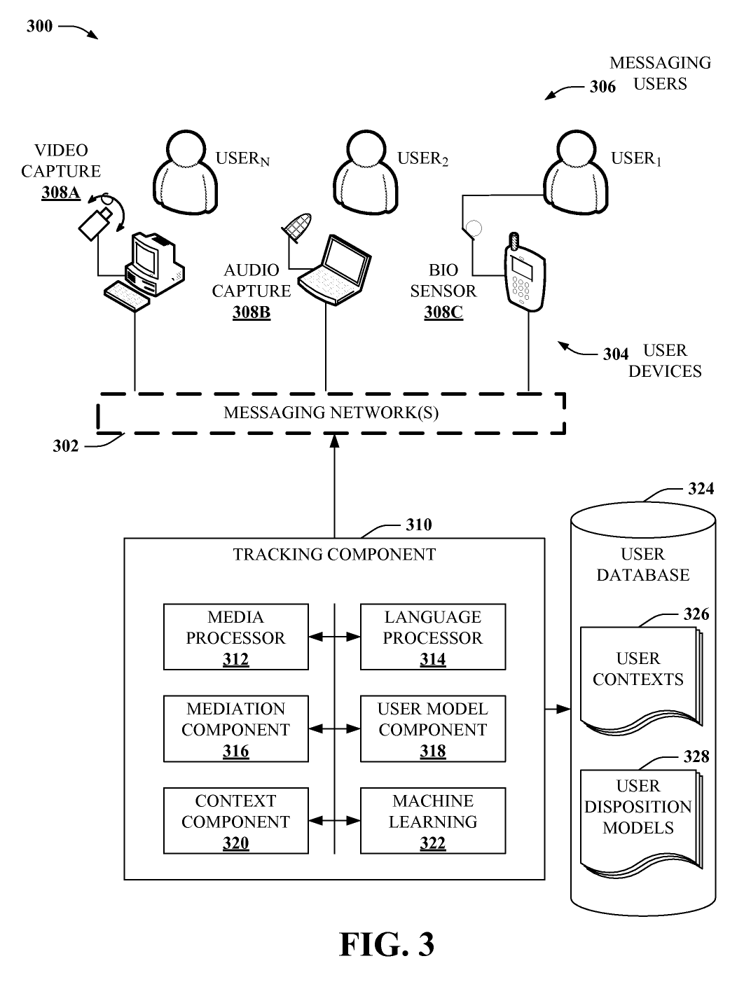

Participant context can be determined in multiple manners. In some aspects, context can be determined by mining data pertinent to the participants. In other aspects, participant context can be determined by analyzing user usage of a communication device or messaging application and generating a model that characterizes typical, preferred, un-preferred or unusual usage patterns, as well as changes or variations in such patterns over time, across multiple messaging platforms (e.g., e-mail, IM, SMS, blog, forum posts, electronic voice communication) or communication devices (e.g., laptop, mobile phone, personal digital assistant [PDA], desktop computer), or among different social, familial, task-related or business settings. According to still other aspects, user biometric information can be obtained from one or more biometric sensors (e.g., see FIG. 3, infra) to provide physical or emotional response data of participants based on electronic communication with other participants. In some instances, context could also be determined by querying specialized services for reporting user context. Status information, uploaded by users to an online or networked server, is one pertinent example. More sophisticated structures could include user feedback servers that collect status, sentiment or disposition information from users pertaining to themselves, to received or sent messages, or to other participants. For instance, a user could rate a received message, as well as additions made by various participants in a chain of messages. Furthermore, the user could rate their response to the message, its utility to their current interests, and so on. Feedback data (e.g., ratings) provided by a set of users can be aggregated at a feedback server and made available for inferring context of a subset of the users. According to still other aspects, a combination of the foregoing characterization mechanism can be employed to determine context for a participant.

As a particular example, user devices can be searched to identify calendar applications, or the like, providing scheduled tasks, meetings, appointments, and so on, for the participant, as well as logistical information (e.g., time, location) thereof. Such information can be utilized to predict a participant's location, current status (e.g., driving, sleeping, on a flight, at an airport, in a meeting, playing with kids, watching a ballgame), what communication device(s), network aliases or messaging applications utilized to interact with the participant, what other persons might be in the company of the participant, and so on. As another example, customization component 108 can employ data mining with respect to electronic social networking applications to identify contemporaneous tasks, meetings, appointments, participant status, personal inter-relationships and contexts of such relationships (e.g., familial, business, social, direct or indirect through one or more persons, including context or purpose of the relationship) or other contextual information pertaining to participants. As utilized herein, participant context can include personal context, such as tasks the participant is involved in, meetings scheduled in the near future or at a time relevant to the message context, communication devices or communication aliases participants are logged onto, communication preferences or habits, etc., as well as physical context, including time relative the participant, position location of the participant, participant status, and so forth.

Based on the message context and participant context(s), customization component 108 can generate one or more modifications to the content, style, format or logistics of the electronic message 106. The modifications can be based on one or more rules or sets of rules, communication models, or the like, developed for identified message participants, as a function of message context. The rules can specify a desired message sentiment, desired content, desired style or format based on prior communications and responses, explicit user input, participant context, seed data compiled from a benchmark set of electronic messaging users, etc. By comparing various aspects of the message 106 with the rules, differences in message context and desired participant context can be identified, and changes determined to match the respective contexts.

As an illustrative example, if language employed in a message is determined by the analysis component 104 to be abrasive for a particular context (e.g., based on language employed, context or biometric feedback of a sender), customization component 108 can determine whether such content is suited to the communication, in view of known goals, sentiments or dispositions of respective participants. The determination could be based on inferred or explicit participant intent and a broader context including past communications, results of such communications, relationships between the participants (e.g., employer-employee, sibling, parent-child, acquaintance, close friend), occasion discussed, user biometric feedback data, personality profile, or the like, in view of one or more specified or inferred user communication goals. If the content is determined to be suitable to the participants based on the context of communication, the modification could simply include results of the message context analysis and that such content is suitable for the message, optionally as a function of identified user goals. Where the content is deemed unsuitable, the modification can include different content (e.g., different language, wording, punctuation, grammar, graphical indicators such as emoticons) or style deemed suitable to respective goals and sentiments/dispositions of the participants. It should be appreciated that suitability of content and modifications can be different for each message participant or interactions of sets of participants, depending on participant context.

As an additional example, customization component 108 can modify logistical aspects of electronic messaging to improve delivery rates, maximize comprehension, improve relevancy, or the like. For instance, customization component 108 can infer from participant context whether a recipient is most likely to receive a message, receive the message in a timely fashion (e.g., based on participant status), respond to a message, have access to requested information, and so on. Such an inference can be based on recipient messaging history, preferences or habits, what device or messaging application the recipient is currently logged onto, whether recipient is in a meeting or otherwise pre-occupied, etc. Thus, if a participant is determined to be unlikely to receive an e-mail message at a particular time, (e.g., because a recipient is not currently logged on to e-mail), customization component 108 could attempt to identify an alternative communication application (e.g., IM, phone) more suited to facilitating immediate or near-term interaction. In such case, the message modification can include reformatting the message for, or transmitting the message over, a different electronic communication platform.

It should be appreciated that various other suitable examples and applications of message customization based on message and participant context exist within the scope of the subject disclosure. It is not feasible that every possible example or application be articulated in this document. However, those applications/examples made known by way of the context provided herein are considered as part of the subject disclosure, in addition to those applications/examples specifically articulated herein.

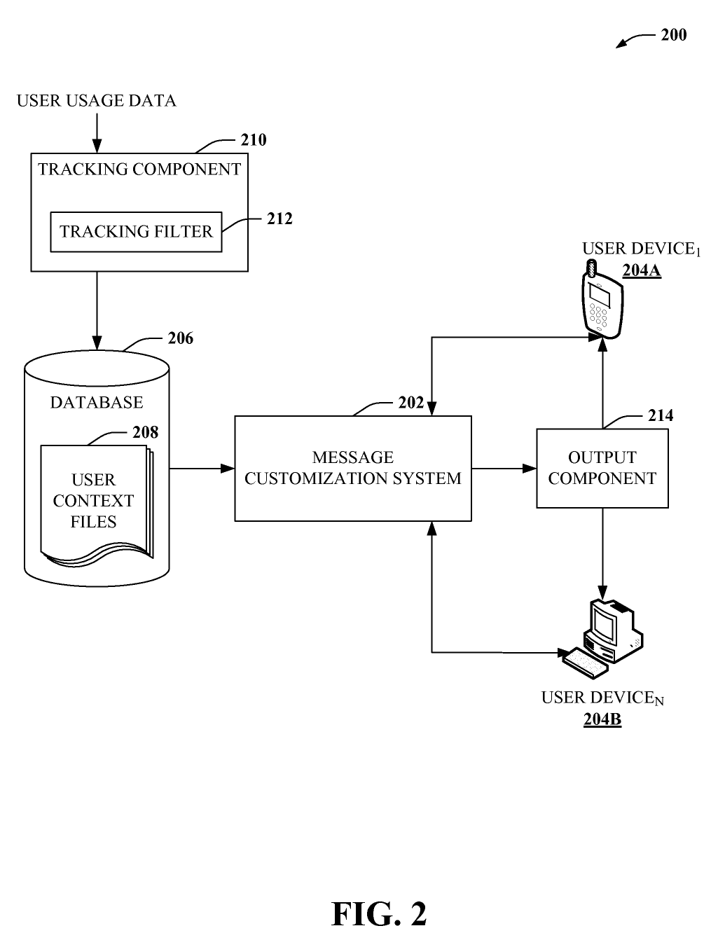

FIG. 2 depicts a block diagram of an example system 200 for determining participant context and employing such context in providing customized electronic messaging. System 200 can include a message customization system 202 that can analyze transmitted or received electronic messaging, or compilation of electronic messages, at one or more user devices 204A, 204B. Based on the analysis, data is collected that characterizes content, style, format or logistics of the message, or parent messages (e.g., previous messages in a chain of replied, forwarded or copied messages). The collected data can be referenced against contextual models to yield a message context for the analyzed message. Additionally, message customization system 202 can access a user database 206 that stores context files 208 for one or more users of the communication devices 204A, 204B. Electronic messaging can be customized based on message context in comparison with user context, to increase utility and efficiency of electronic communication, determine a most convenient time/location/alias with which to contact a user, supplement communication with rich contextual data pertaining to the message content, or trim the content for increased consumption of data, as a function of user preferences or user context.

System 200 can comprise a tracking component 210 that monitors user usage of a communication device 204A, 204B to generate user context data. By monitoring such usage, tracking component 210 can compile device, system (e.g., operating system, ‘background’ services or executables) or application (e.g., user applications, including messaging applications) data characterizing a use context of a user of the communication device(s) 204A, 204B. As such, tracking component 210 can collect data pertaining to user usage of different types of communication devices (e.g., smart phone, laptop, desktop), messaging platforms (e.g., e-mail, IM, SMS), or messaging applications (e.g., particular e-mail or IM program). Collected data can further specify frequency, rate or time of use (e.g., time of day, day of week, month/season of the year, etc.) relative to the various devices/applications/platforms. In some aspects, collected data can include propensity to respond to, delete, or forward received messages, propensity to copy additional persons to, or remove persons from, forwarded/replied messages, and so on. In other aspects, tracking component 210 can analyze content of messages to determine topics of interest, or frequencies with which topics are included in messages, as well as context surrounding such topics of interest. Thus, for instance, if content pertaining to weather often appears in conjunction with social events, and more often during the months of December, January and February (in the northern hemisphere for instance), tracking component 210 could infer that a device user has an interest in weather, at least when discussing social events, and particularly during the winter.

In addition to the foregoing, tracking component 210 can collect data pertaining to different networks of individuals that a user interacts with. Such networks can include event or task-related interactions, business interactions, social interactions, familial interactions, random encounters on electronic networks or in person (e.g., determined by a location-aware mobile device), and so on. The interactions can be utilized to refine a participant context for a user. Additionally, the context can also be refined based on content of communication conducted during an interaction, emotional or biometric responses of individuals during such interactions, logistics of the interaction (e.g., duration, position location, time of day, etc.), and the like. Tracking component 210 can reference interaction and context data as a function of communication participants or social network(s) involving one or more participants.

According to some aspects, tracking component 210 can include a tracking filter 212 that limits user usage analysis and data collection with respect to the communication devices 204A, 204B. The tracking filter 212 can thus facilitate communication and usage privacy, for instance, by disabling usage analysis/data collection, or enabling analysis/collection for only a subset of functions or data. As a particular example, a user profile can provide a checklist of various subsets of usage analysis, such as analysis of real-time user communications, message content, message style, fonts, user usage histories, time-based usage statistics, inter-device communications, recipient contexts, and so on. Items checked by a user can be selectively monitored by tracking component 210, whereas unchecked items are not analyzed, or no data is collected pertaining to unchecked items. In such an example, tracking filter 210 can enable a user to selectively analyze a specified subset of functions and collect only a specified category of data there from. Thus, tracking component 210 can be restricted or limited for user privacy.

Data collected by tracking component 210 or results of communication device usage analysis can be stored in user context files 208 at a user context database 210. The context files can store usage data as a function of user identity or alias, communication device 204A, 204B, communication platform or application, analyzed device/application functions employed by a user, user preferences (e.g., explicitly defined or inferred from usage-analysis), message recipient(s), and so forth. The user context data (208) can be provided to message customization system 202 to provide a standard or threshold against which electronic messages can be measured. Message customization system 202 can determine differences in message context and participant context, and identify aspects of message content, style, format, logistics, etc., resulting in those differences. Changes to one or more aspects of the message are identified and provided to an output component 214.

Output component 214 can reformat an electronic message to be consistent with changes output by message customization system. Changes can include adding contextual data to the message that is pertinent to message context and recipient interest, profile or context. Thus, for instance, if a recipient context indicates a preference for weather information, especially when traveling or planning a trip, the changes can include weather information local to the user, or to a destination identified in the message.

Once a message is updated to include specified changes, output component 214 can provide the modified message to the user device 204A, 204B. In such context, the message can be initiated, compiled or transmitted at the user device 204A, 204B or can be received at such device 204A, 204B. In the former case, the modified message can be output to the initiating device for review by a user prior to transmitting the message. In the latter case, the modified message can be provided to the recipient user device (204A, 204B) as a modified, received message. In either case, modifications can be displayed in a distinct manner from original content/style/context, to enable a user to visually distinguish modified and original information.

In some aspects of the subject disclosure, a message modified at a transmitting device (204A, 204B) can be further modified at a recipient device (204A, 204B). Thus, a modified message can be further updated based on recipient user preferences, usage context(s), data collection filtering at the recipient device, and so on. In other aspects (e.g., where message customization system 202 is a central entity managing participant contexts, interests and preferences for a plurality of devices, communication platforms and applications), the modification can incorporate both sender and recipient contexts based on analysis of both devices or usage patterns of respective device users. In the latter aspects, only a single modification per device-device transmission is implemented, whereas in the former aspects a single message could be modified at the sending device and recipient device, based on disparities in user preferences or user contexts, maintained or analyzed locally at such devices.

FIG. 3 depicts a block diagram of an example system 300 that provides user device usage, message content or physical response or interaction analysis for customized electronic messaging. System 300 can comprise one or more messaging networks 302, including e-mail, peer-to-peer, IM, SMS, mobile telephone, Internet, intranet or like networks, or combinations thereof (e.g., an IM network established on the Internet employing transport control protocol/Internet protocol [TCP/IP]). The messaging network(s) 302 facilitate electronic communication between a set of user devices 304 operated by a set of users 306. As described herein, a tracking component 310 can monitor device usage, as well as messages exchanged between the user devices 304 to determine message and user context.

According to particular aspects of the subject disclosure, one or more sensor devices 308A, 308B, 308C can be employed to monitor user physical activity, interactions, responses, stimuli, and the like. As particular examples, the sensor devices can comprise a video capture device 308A (e.g., camera, webcam, video camera), an audio capture device 308B (e.g., microphone) or biometric sensor(s) 308C (e.g., heart monitor, thermal imaging camera to measure change in body temperature, blood pressure sensor, etc.). The video capture device 308A can include, in some aspects, face recognition applications to identify the user or other persons in view of the camera. Additionally, the video capture device 308A can identify physical responses indicating physical or emotional experiences of a person. Examples can include shaking to indicate experience of cold or strong emotion, sweating indicating nervousness or experience of heat, repetitive mannerisms, and so on. The audio capture component 308B can record conversations with other users, whether person to person or employing an electronic voice device (e.g., telephone). The biometric sensor(s) 308C can identify changes in user heart rate, blood pressure, body or skin temperature, and so on. Data recorded by the devices 308A, 308B, 308C can be provided to the tracking component 310. A media processor 312 can analyze the audio, video or biometric data to infer user responses, emotions, sensitivities, and emotions relative activities conducted by the user, including communication and content or context thereof.

According to some aspects of the subject disclosure, tracking component 310 can further comprise a language processor 314 utilized to interpret written or spoken communications and associate a meaning or context with such communications. Additionally, tracking component 310 can comprise a context component 320 that can employ various other devices (not depicted) for collecting data and analyzing user personal and physical context. Examples of such devices in terms of physical context can include a location sensor(s) that determines or obtains a position location for a participant (e.g., a global positioning system [GPS], mobile network interface that obtains a position of a mobile device [304], etc.) or a timing component that determines a current time relative the participant. Devices in terms of personal context can include a scheduling component (e.g., electronic calendar, meeting tracker, task tracker) that determines or stores a task, workgroup, or activity the participant is involved with, a user interface for explicit contextual input by a user or message participant, or a social network interface that can obtain or identify other persons associated with the participant and interests, tasks or context of inter-relatedness of such persons, or suitable combinations of such devices.

As described herein, data collected about a user can be utilized to generate a context model for a user (306) with respect to current user context data. Additionally, a mediation component 316 can analyze user usage or context data over time, over a plurality of communication partners (306) or across a plurality of communication devices 304, and update the user context model based on identified changes in the data. Furthermore, a user modeling component 318 can employ the updated participant context to generate a disposition model for the user (306). The disposition model can provide an inference of user communication preferences, preferred devices (304), applications or messaging platforms based on historical user context data and variations in such data. Based on the disposition model, tracking component 310 can determine a current disposition of the user 306. User context and disposition data can be stored in respective files 326, 328 at a user database 324.

According to at least some aspects of the subject disclosure, tracking component 310 can employ a machine learning and optimization component 322 to optimize data analysis over time or over multiple iterations of analyzed data. For instance, accurately characterizing or identifying a user context based on captured media data can be one example of optimization. Another example can comprise analyzing user communications and correlating the communications with user context. Still other examples can comprise correlating user activities with other messaging participants to generate an overall characterization of user contest of a set of users.

In order to optimize data analysis, machine learning and optimization component 322 can utilize a set of models (e.g., user interface model, text-to-speech or speech-to-text models, user biometric response model, user disposition-physical response model, language processing model, inter-user interaction model, statistical models based on the foregoing, etc.) in connection with determining or inferring user context based on user actions, activities or communication content. The models can be based on a plurality of information (e.g., media capture data, manual data entry, cross-network communication, etc.). Optimization routines associated with machine learning and optimization component 322 can harness a model(s) that is trained from previously collected data, a model(s) that is based on a prior model(s) that is updated with new data, via model mixture or data mixing methodology, or simply one that is trained with seed data, and thereafter tuned in real-time by training with actual field data based on parameters modified as a result of error correction instances.

In addition, machine learning and optimization component 322 can employ machine learning and reasoning techniques in connection with making determinations or inferences regarding optimization decisions, such as correlating explicit user input with inferred user context, across a plurality of users and device/network usage contexts of such users. For example, machine learning and optimization component 322 can employ a probabilistic-based or statistical-based approach in connection with identifying and/or updating a user disposition, physical/emotional state or activity state based on previous biometric sensor data collected for the user, or similar data collected for a plurality of similar users. Inferences can be based in part upon explicit training of classifier(s) (not shown), or implicit training based at least upon one or more monitored results, and the like.

Machine learning and optimization component 322 can also employ one of numerous methodologies for learning from data and then drawing inferences from the models so constructed (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various aspects described herein. Methodologies employed by tracking module 310 can also include mechanisms for the capture of logical relationships such as theorem provers or heuristic rule-based expert systems. Inferences derived from such learned or manually constructed models can be employed in other optimization techniques, such as linear and non-linear programming, that seek to maximize probabilities of error. For example, maximizing an overall accuracy of correlations between user device usage, inter-personal interactions or message content can be achieved through such optimization techniques.

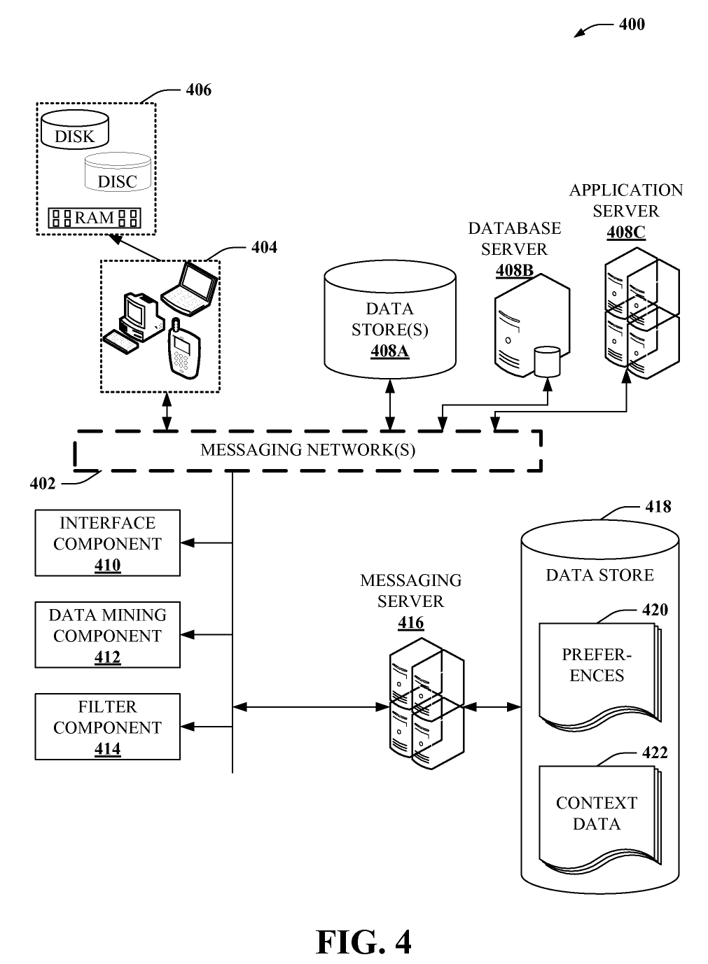

FIG. 4 depicts a block diagram of an example system 400 that provides data mining pertinent to message context or participant context to facilitate providing rich contextual information for electronic messaging. System 400 comprises a messaging network(s) 402 for facilitating communication between user communication devices 404. System 400 further comprises a data mining component 412 and a network interface component 40 through which the data mining component 412 can access, query and receive data from the network(s) 402 and devices (404, 408A, 408B, 408C) coupled with the network(s) 402. The data mining component 412 can query various data stores (408A), database servers (408B) or application servers (408C), or the like, or communication device data stores 406 coupled with the network(s) 402 in order to obtain data. Such data can be pertinent to content of a message, context of a message, communication participant's interests or contexts, or the like. User interests, contexts or preferences can be stored in various files 420, 422 on a user context data store 418. A messaging server 416 can act as an interface to the data store 418 and obtain information pertinent to participants of an electronic message. Such information can be utilized to search for additional contextual information pertinent to the message or user contexts/interests. Accordingly, the data mining component 412 can enrich electronic messaging with additional data pertinent to the message or content or context thereof.

As one example of the foregoing, data mining component 412 can search for data pertinent to a communication user's interests or context, relevant to content of an electronic message in which the user is a participant. If the message content discusses a meeting, data mining component 412 can access a filtering component 414 and determine suitable network queries for obtaining data pertinent to the meeting and further pertinent to interests or context of the user. If the user is interested in weather, driving directions, location, and locale information surrounding such location, the filter component 414 can generate queries to obtain data pertinent to such items. Additionally, if the user enjoys entertainment after meetings, such as movies, shows, sporting events, and so forth, suitable venues and events proximate the meeting location can be searched for via the network(s) 402. Further to the above, user consumption or selection of updated contextual information can be utilized to weight an inferred user interest relative other such interests. As one example to illustrate, where a user has selected entertainment data to be added to a message, an inference that entertainment context would be of interest to the user can be given a higher weight among other contexts for future messaging. Such data can then be output to a message customization system (not depicted, but see e.g., FIG. 1) to update an electronic message to include the rich contextual information obtained from the data mining component 412.

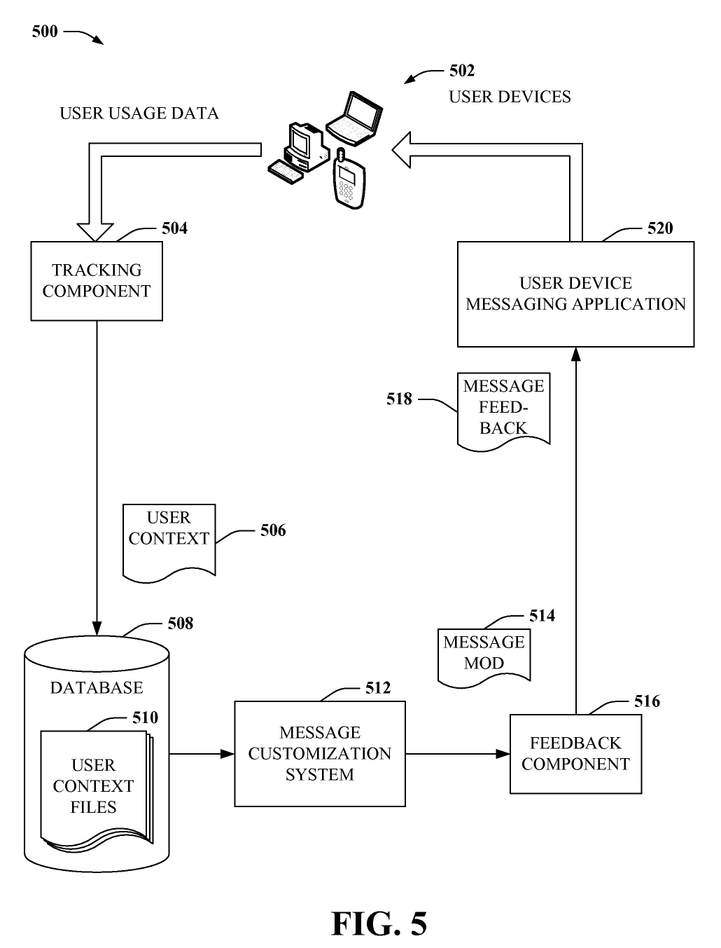

FIG. 5 depicts a block diagram of an example system 500 that delivers customized messaging to user devices according to aspects of the subject disclosure. System 500 comprises one or more user communication devices 502 with which users can conduct electronic communication with other such devices (502). A tracking component 504 can monitor user usage of the devices 502, as described herein, to obtain contextual or disposition data pertinent to communication participants. The data 506 can be submitted for storage to a database 508 and maintained in user context files 510. Additionally, the user context files 510 can be referenced by a message customization component 512 to determine a current user context and topics of interest for the user or a communication recipient. Based on the current user/recipient context and a context of an electronic message initiated by the user, message customization system 512 can generate modifications to the message to provide additional data pertinent to the message context, or adapt content, style, format or logistics of the message to the recipient's context or interests. In some aspects, one or more network data stores can be mined for additional data pertinent to the message context or user context (e.g., see FIG. 4, supra).

Message customization system 512 can output a message modification file 514 and send the file 514 to a feedback component 516. The feedback component 516 can format the message modification file 514 for compatibility with a user device messaging application 520. A formatted file 518, comprising a modified message, can then be delivered to the user device messaging application 520, which can output the message at a user interface of the user device 502. The modified message can be reviewed by a user of the device 502, and modified manually, or transmitted, or deleted, etc. Alternatively, the modified message can automatically be transmitted by the messaging application 520 via the user device 502 upon receipt from the feedback component 516. Display of the message or automatic transmission thereof can be established as a function of user profile information stored at the user device 502.

As described, system 500 can implement predictive feedback for a user of a communication device, based on message context/content and recipient context. Thus, if a recipient often communicates or participates in activities with members of a social network, the message can be updated with data pertinent to such members and the content of the message. As another example, if the recipient typically attends meetings when one or more other persons also attend such meetings, the message can be modified with contextual data pertaining to such other persons (e.g., indicating whether they plan to attend the meeting). Thus, system 500 can act as a research assistant and message editor, providing a rich set of contextual information for other participants of a communication, based on message content. Modified messages can be displayed to the user as suggestions, and incorporated or further modified as the user deems fit according to some aspects. Accordingly, system 500 can provide a powerful tool for improving electronic communications between device users.

The aforementioned systems have been described with respect to interaction between several components. It should be appreciated that such systems and components can include those components or sub-components specified therein, some of the specified components or sub-components, and/or additional components. For example, a system could include message customization system 102, tracking component 210, and filter component 212, data mining component 412, and machine learning and optimization component 322, or a different combination of these and other components. Sub-components could also be implemented as components communicatively coupled to other components rather than included within parent components. Additionally, it should be noted that one or more components could be combined into a single component providing aggregate functionality. For instance, data mining component 412 can include filter component 414, or vice versa, to facilitate generating context-relative queries and searching network or device data stores based on such queries by way of a single component. The components may also interact with one or more other components not specifically described herein but known by those of skill in the art.

Furthermore, as will be appreciated, various portions of the disclosed systems above and methods below may include or consist of artificial intelligence or knowledge or rule based components, sub-components, processes, means, methodologies, or mechanisms (e.g., support vector machines, neural networks, expert systems, Bayesian belief networks, fuzzy logic, data fusion engines, classifiers . . . ). Such components, inter alia, and in addition to that already described herein, can automate certain mechanisms or processes performed thereby to make portions of the systems and methods more adaptive as well as efficient and intelligent.

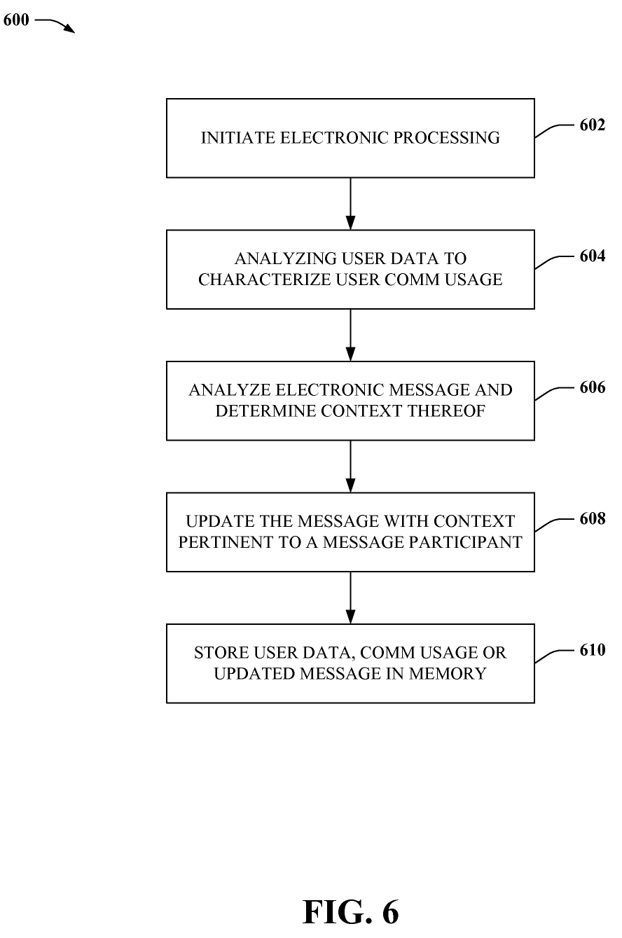

In view of the exemplary systems described supra, methodologies that may be implemented in accordance with the disclosed subject matter will be better appreciated with reference to the flow charts of FIGS. 6-8. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter. Additionally, it should be further appreciated that the methodologies disclosed hereinafter and throughout this specification are capable of being stored on an article of manufacture to facilitate transporting and transferring such methodologies to computers. The term article of manufacture, as used, is intended to encompass a computer program accessible from any computer-readable device, device in conjunction with a carrier, or media.

FIG. 6 illustrates a flowchart of an example methodology 600 for customizing electronic messaging based on device usage context of messaging participants. Method 600, at 602, can initiate electronic processing for components of a message customization system (e.g., see FIGS. 1 or 5, supra). At 604, method 600 can analyze user usage data collected at or provided by a set of communication devices to characterize a communication usage context for a set of users of such devices. The usage context can indicate user communication preferences, including preferred communication platforms, devices or applications. Additionally, the usage context can indicate a current personal or physical context of a user. According to still other aspects, the usage context can include a user disposition determined from physical sensor devices focused on the user (e.g., biometric sensors, audio capture devices, video capture devices, and so on). At 606 method 600 can analyze an electronic message (e.g., for content, style, format or logistical information) and determine a context of the message. At 608, method 600 can update the message with a subset of context data pertinent to the message context and to a usage context of a participant of the message (e.g., a sender, recipient, etc.). At 610, method 600 can store user data, communication usage data or updated message content, style, format or logistical information in memory for further reference, utilization in message customization, or for time, device or user-based analysis.

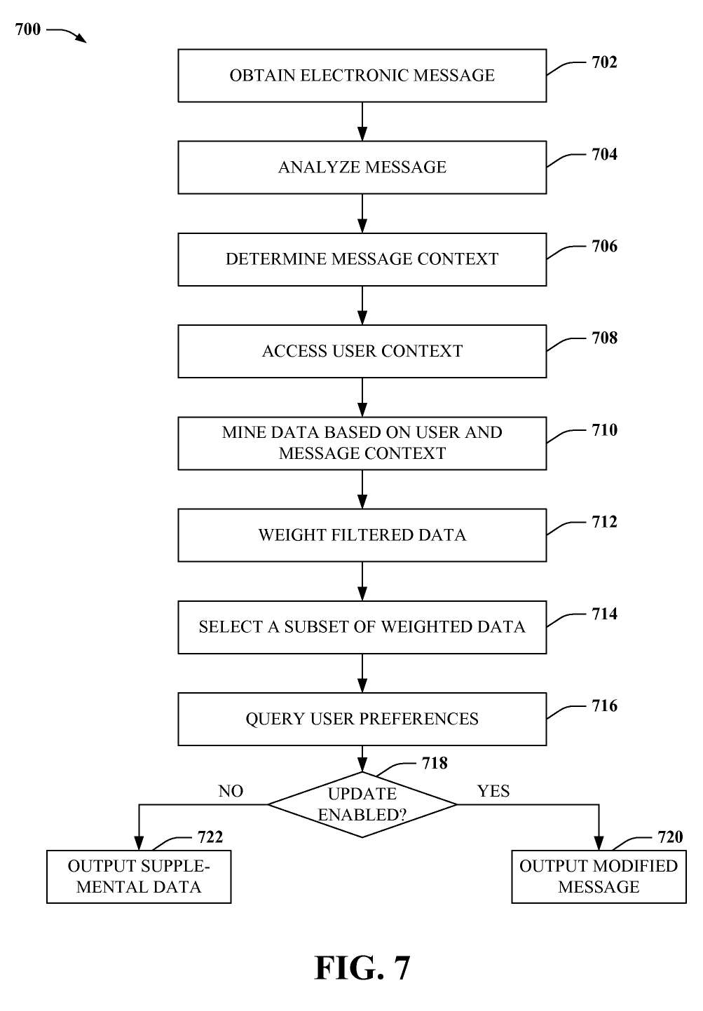

FIG. 7 depicts a flowchart of an example methodology 700 for providing rich contextual data for customized electronic messaging according to further aspects. At 702, method 700 can obtain an electronic message, or a subset of content of such message including identity or messaging alias of one or more participants of the message. At 704, method 700 can analyze the message or content and, at 706, determine a context for the message, as described herein. At 708, method 700 can access a database for contextual information for one or more message participants. The contextual information can be based on user usage data for one or more communication devices, messaging platforms or messaging applications. Additionally, the contextual data can be referenced as a function of message content, message participants, or the like. At 710, method 700 can mine additional data pertaining to the participant contextual information and message context. The data can be mined from a subset of communication devices employed to conduct electronic messaging, data stores located on a messaging network (e.g., IM network, SMS network) or on the Internet, an intranet, or a local network employed by message participants. At 712, method 700 can weight data as a function of relevance to the message context of participant context. At 714, a subset of the weighted data, meeting a relevance threshold for instance, can be selected. At 716, user preference files can be queried to obtain user preferences pertinent to electronic messaging, or pertinent to particular messaging content/context. At 718, a determination can be made as to whether automatic message modification is enabled for one or more participants. If so, method 700 can proceed to 720 and output a message that is modified based on the selected data. The message can be displayed at a sender's communication device for approval, or transmitted to recipients (e.g., based on sender preferences). If the automatic message modification is not enabled, method 700 can proceed to 722 where the selected subset of data is output as supplemental contextual data for use by a message sender/initiator.

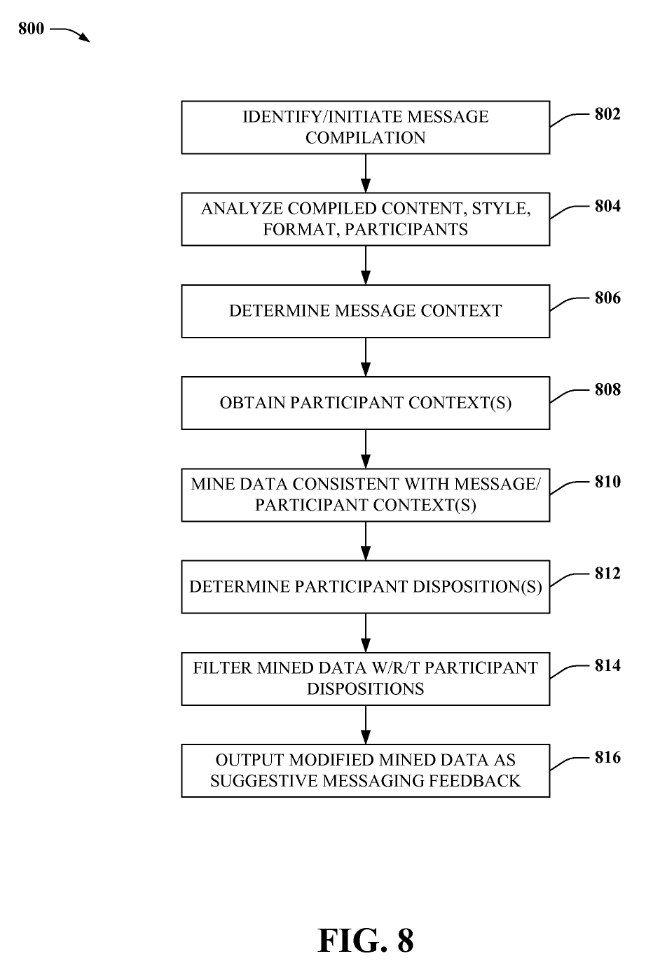

FIG. 8 illustrates a flowchart of a sample methodology 800 for providing predictive feedback for customizing electronic messaging to participant disposition. At 802, method 800 can identify or initiate compilation of an electronic message. At 804, method 800 can analyze compiled message content, style, or format, or determine participants to the message (e.g., based on aliases input to a “To” field, “Copy” field, “Blind Copy” field, or the like). At 806, method 800 can analyze content, style, format or logistical information pertaining to the message, or like information, and determine a context of the message as described herein. Additionally, at 808, method 800 can obtain contextual information for one or more message participants. At 810, method 800 can mine additional data consistent with the message context or participant context(s). At 812, method 800 can determine a disposition of one or more participants. At 814, method 800 can filter mined data with respect to the determined participant disposition(s). At 816, method 800 can output filtered data as suggestive feedback for incorporation into a message, or as a template for modifying the message, consistent with participant disposition(s).

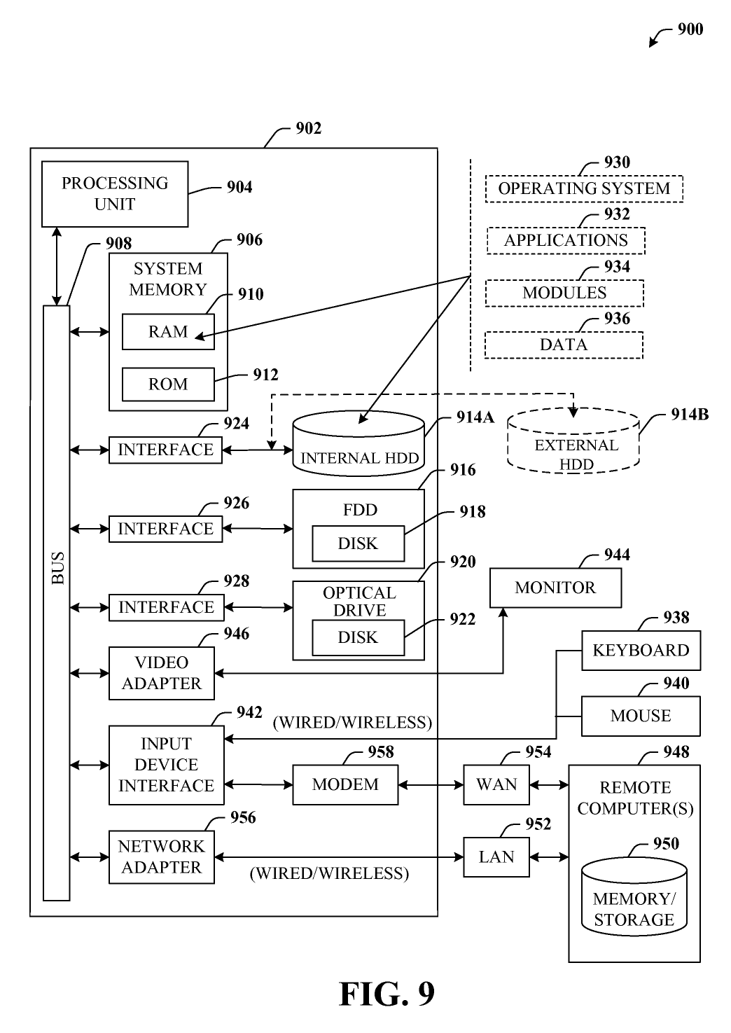

Referring now to FIG. 9, there is illustrated a block diagram of an exemplary computer system operable to execute the disclosed architecture. In order to provide additional context for various aspects of the claimed subject matter, FIG. 9 and the following discussion are intended to provide a brief, general description of a suitable computing environment 900 in which the various aspects of the claimed subject matter can be implemented. Additionally, while the claimed subject matter described above can be suitable for application in the general context of computer-executable instructions that can run on one or more computers, it will be recognized that the claimed subject matter also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media can include both volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the above should also be included within the scope of computer-readable media.

Continuing to reference FIG. 9, the exemplary environment 900 for implementing various aspects of the claimed subject matter includes a computer 902, the computer 902 including a processing unit 904, a system memory 906 and a system bus 908. The system bus 908 couples to system components including, but not limited to, the system memory 906 to the processing unit 904. The processing unit 904 can be any of various commercially available processors. Dual microprocessors and other multi-processor architectures can also be employed as the processing unit 904.

The system bus 908 can be any of several types of bus structure that can further interconnect to a memory bus (with or without a memory controller), a peripheral bus, and a local bus using any of a variety of commercially available bus architectures. The system memory 906 includes read-only memory (ROM) 910 and random access memory (RAM) 912. A basic input/output system (BIOS) is stored in a non-volatile memory 910 such as ROM, EPROM, EEPROM, which BIOS contains the basic routines that help to transfer information between elements within the computer 902, such as during start-up. The RAM 912 can also include a high-speed RAM such as static RAM for caching data.

The computer 902 further includes an internal hard disk drive (HDD) 914A (e.g., EIDE, SATA), which internal hard disk drive 914A can also be configured for external use (1014B) in a suitable chassis (not shown), a magnetic floppy disk drive (FDD) 916, (e.g., to read from or write to a removable diskette 918) and an optical disk drive 920, (e.g., reading a CD-ROM disk 922 or, to read from or write to other high capacity optical media such as the DVD). The hard disk drive 914, magnetic disk drive 916 and optical disk drive 920 can be connected to the system bus 908 by a hard disk drive interface 924, a magnetic disk drive interface 926 and an optical drive interface 928, respectively. The interface 924 for external drive implementations includes at least one or both of Universal Serial Bus (USB) and IEEE1394 interface technologies. Other external drive connection technologies are within contemplation of the subject matter claimed herein.

The drives and their associated computer-readable media provide nonvolatile storage of data, data structures, computer-executable instructions, and so forth. For the computer 902, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the exemplary operating environment, and further, that any such media can contain computer-executable instructions for performing the methods of the claimed subject matter.

A number of program modules can be stored in the drives and RAM 912, including an operating system 930, one or more application programs 932, other program modules 934 and program data 936. All or portions of the operating system, applications, modules, and/or data can also be cached in the RAM 912. It is appreciated that the claimed subject matter can be implemented with various commercially available operating systems or combinations of operating systems.

A user can enter commands and information into the computer 902 through one or more wired/wireless input devices, e.g., a keyboard 938 and a pointing device, such as a mouse 940. Other input devices (not shown) can include a microphone, an IR remote control, a joystick, a game pad, a stylus pen, touch screen, or the like. These and other input devices are often connected to the processing unit 904 through an input device interface 942 that is coupled to the system bus 908, but can be connected by other interfaces, such as a parallel port, an IEEE1394 serial port, a game port, a USB port, an IR interface, etc.

A monitor 944 or other type of display device is also connected to the system bus 908 via an interface, such as a video adapter 946. In addition to the monitor 944, a computer typically includes other peripheral output devices (not shown), such as speakers, printers, etc.

The computer 902 can operate in a networked environment using logical connections via wired and/or wireless communications to one or more remote computers, such as a remote computer(s) 948. The remote computer(s) 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wired/wireless connectivity to a local area network (LAN) 952 and/or larger networks, e.g., a wide area network (WAN) 954. Such LAN and WAN networking environments are commonplace in offices and companies, and facilitate enterprise-wide computer networks, such as intranets, all of which can connect to a global communications network, e.g., the Internet.

When used in a LAN networking environment, the computer 902 is connected to the local network 952 through a wired and/or wireless communication network interface or adapter 956. The adapter 956 can facilitate wired or wireless communication to the LAN 952, which can also include a wireless access point disposed thereon for communicating with the wireless adapter 956.

When used in a WAN networking environment, the computer 902 includes a modem 958, is connected to a communications server on the WAN 954, or has other means for establishing communications over the WAN 954, such as by way of the Internet. The modem 958, which can be internal or external and a wired or wireless device, is connected to the system bus 908 via the serial port interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least WiFi and Bluetooth™ wireless technologies. Thus, the communication can be a predefined structure as with a conventional network or simply an ad hoc communication between at least two devices.

WiFi, or Wireless Fidelity, allows connection to the Internet from a couch at home, a bed in a hotel room, or a conference room at work, without wires. WiFi is a wireless technology similar to that used in a cell phone that enables such devices, e.g., computers, to send and receive data indoors and out; anywhere within the range of a base station. WiFi networks use radio technologies called IEEE802.11 (a, b, g, n, etc.) to provide secure, reliable, fast wireless connectivity. A WiFi network can be used to connect computers to each other, to the Internet, and to wired networks (which use IEEE802.3 or Ethernet). WiFi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 9 BaseT wired Ethernet networks used in many offices.

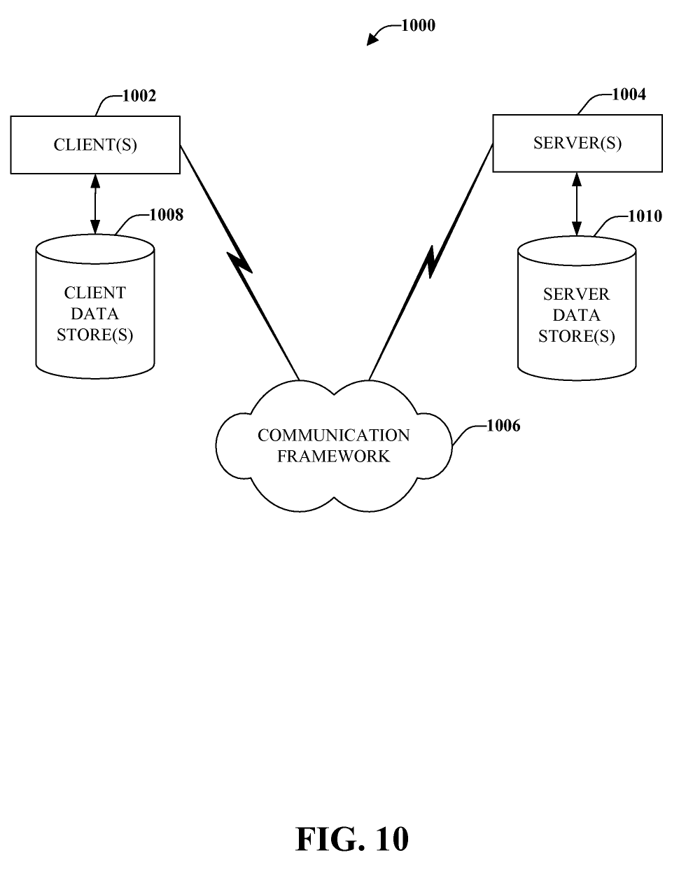

Referring now to FIG. 10, there is illustrated a schematic block diagram of an exemplary computer communication system 1000 operable to execute remote communication between electronic devices according to aspects of the disclosed architecture. The system 1000 includes one or more client(s) 1002. The client(s) 1002 can be hardware and/or software (e.g., threads, processes, computing devices). The client(s) 1002 can house cookie(s) and/or associated contextual information by employing the claimed subject matter, for example.

The system 1000 also includes one or more server(s) 1004. The server(s) 1004 can also be hardware and/or software (e.g., threads, processes, computing devices). The servers 1004 can house threads to perform transformations by employing the claimed subject matter, for example. One possible communication between a client 1002 and a server 1004 can be in the form of a data packet adapted to be transmitted between two or more computer processes. The data packet can include a cookie and/or associated contextual information, for example. The system 1000 includes a communication framework 1006 (e.g., a global communication network such as the Internet) that can be employed to facilitate communications between the client(s) 1002 and the server(s) 1004.

Communications can be facilitated via a wired (including optical fiber) and/or wireless technology. The client(s) 1002 are operatively connected to one or more client data store(s) 1008 that can be employed to store information local to the client(s) 1002 (e.g., cookie(s) and/or associated contextual information). Similarly, the server(s) 1004 are operatively connected to one or more server data store(s) 1010 that can be employed to store information local to the servers 1004.

What has been described above includes examples of the various embodiments. It is, of course, not possible to describe every conceivable combination of components or methodologies for purposes of describing the embodiments, but one of ordinary skill in the art can recognize that many further combinations and permutations are possible. Accordingly, the detailed description is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the embodiments. In this regard, it will also be recognized that the embodiments include a system as well as a computer-readable medium having computer-executable instructions for performing the acts and/or events of the various methods.

In addition, while a particular feature may have been disclosed with respect to only one of several implementations, such feature can be combined with one or more other features of the other implementations as may be desired and advantageous for any given or particular application. Furthermore, to the extent that the terms “includes,” and “including” and variants thereof are used in either the detailed description or the claims, these terms are intended to be inclusive in a manner similar to the term “comprising.”

What is claimed is:

1. A message customization system for electronic messaging, comprising:
at least one processor that executes the following components:
an analysis component that evaluates content of an electronic message and determines a context for the message;
a customization component that outputs a modification to the electronic message based on the message context and a current context of a message participant; and
memory for storing the message or participant context.

2. The system of claim 1, further comprising an output component that updates the message according to the modification.

3. The system of claim 2, the output component adds contextual information to message content pertinent to the message context or participant context, interest or profile.

4. The system of claim 1, the analysis component employs language recognition to analyze the message content and infer message context.

5. The system of claim 1, further comprising a tracking component that monitors user usage of a communication device, queries participant context databases, or obtains user input pertinent to messaging or participant context, and compiles device, system or application data characterizing participant context.

6. The system of claim 5, further comprising a mediation component that analyzes user usage data over time, over a plurality of participants or across a plurality of communication devices, and updates the participant context based on identified changes in the data.

7. The system of claim 6, further comprising a user modeling component that employs the updated participant context to generate a disposition model for a participant.

8. The system of claim 7, the modification comprises updated content, style or logistical information consistent with the disposition model.

9. The system of claim 7, the disposition model is generated based at least in part on one or more of the following:
device, operating system (OS) or application preferences for electronic communication;
propensity to open, receive, respond to, forward, or delete received communication;
temporal communication preferences;
emotional sensitivity to electronic communication;
propensity for emotional response to electronic communication;
explicit user input; or
a combination thereof.

10. The system of claim 1, further comprising:
a data mining component that searches network or device data stores and identifies information pertinent to the message context; and
a filtering component that selects a set of data from the identified information that is further pertinent to a participant context or a messaging preference, the modification includes a subset of the set of data.

11. The system of claim 1, further comprising a user database that stores message preferences, user status, message content or participant ratings for electronic messaging participants, optionally indexed as a function of message contexts or respective participant context.

12. The system of claim 11, further comprising a network server that at least one of:
collects participant contexts from user devices for storage at the database; or
distributes stored preference information pertinent to the electronic message or participant context to the tracking component or customization component.

13. The system of claim 10, wherein message preferences are inferred or obtained via user input, and comprise at least one of the following preferences:
update messages with mined data pertinent to message context;
update messages with mined data pertinent to identified or inferred persons, topics or content of interest;
limit message content to identified interests;
adapt received messages to a preferred message style, format or layout;
forward messages to members of a social network having similar interests; or
a combination thereof.

14. The system of claim 1, further comprising a context component that employs at least one of the following to generate the participant context:
a location sensor that determines or obtains a position location for a participant;
a timing component that determines a current time relative the participant;
a scheduling component that provides a task, workgroup, or activity the participant is involved with;
a user interface for explicit contextual input by the participant;
a social network that identifies other persons associated with the participant and interests, tasks or context of inter-relatedness of such persons; or
a combination thereof.

15. A method of providing electronic messaging pertinent to participant context, comprising:
employing a processor to execute the following computer-implemented functions:
analyzing user usage data collected at a set of communication devices to characterize a communication usage context for a set of users;
analyzing content, style or format of an electronic message and determining a context for the message;
updating the message with a subset of context data pertinent to the message context and to a usage context of a message participant; and
employing memory to store the user usage data, usage context or message context.

16. The method of claim 15, further comprising searching network or communication device data stores to obtain the pertinent context data, and referencing the data in a database as a function of participant usage context or message context.

17. The method of claim 15, further comprising weighting pertinence of context data based on a user usage context, and selecting the subset of data relative a threshold weight.

18. The method of claim 15, further comprising employing at least one of the following in characterizing the communication usage context for a user:
user communications with other persons in a social network;
content or context of communication between the user and a person;
context of relatedness between the user and a person;
a topic, person or task of interest inferred about or obtained from the user;
usage history for a communication application or device employed by the user;
preference for a particular communication application or device;
time of day relative the user;
position location of the user or a communication device employed by the user;
calendar appointments recorded for the user;
topic of discussion, participant identity, participant context or participant relatedness relative the user, for a calendar appointment; or
a combination thereof.

19. The method of claim 15, further comprising identifying participants of the message and analyzing usage context, physical context, context of inter-relatedness, social context or business context of the participants in determining the context for the message.

20. A system for customizing electronic messaging to suit participant interest, comprising:
at least one processor that executes the following components:
a tracking component that monitors user usage of a set of communication devices and compiles device, system or application data characterizing user usage context for the set of devices;
an analysis component that evaluates content, style or format of an electronic message and determines a context for the message;
a data mining component that searches network or device data stores and identifies information pertinent to the message context;
a filtering component that selects a subset of the identified information that is within a threshold relevance to a usage context of a message participant
a customization component that outputs a modification to the electronic message based on the message context and selected information, a subset of the modification is applied to the message subject to user preference or user selection; and
memory for storing the message or participant context, or selected information.
